(19) United States
(12) Patent Application Publication
(10) Pub. No.: US 2026/0126705 A1
(43) Pub. Date: May 7, 2026

(54) CAMERA MODULE

(71) Applicant: Samsung Electro-Mechanics Co., Ltd., Suwon-si (KR)

(72) Inventors: Jaegyeong JIN, Suwon-si (KR); Sangwoo KIM, Suwon-si (KR); Daeseul KIM, Suwon-si (KR)

(73) Assignee: Samsung Electro-Mechanics Co., Ltd., Suwon-si (KR)

(21) Appl. No.: 19/186,779

(22) Filed: Apr. 23, 2025

(30) Foreign Application Priority Data
Nov. 7, 2024 (KR) 10-2024-0157472

(51) Int. Cl. G03B 17/12; G02B 7/00; G03B 13/36; H04N 23/54; H04N 23/55

(52) U.S. Cl. CPC G03B 17/12; G02B 7/006; G03B 13/36; H04N 23/54; H04N 23/55

(57) ABSTRACT

A camera module is provided. The camera module includes a lens barrel, a carrier configured to accommodate the lens barrel; an image sensor positioned to face the lens barrel in an optical axis direction, a substrate electrically connected to the image sensor, and a sub-housing having a light transmission hole, and positioned between the lens barrel and the substrate, and configured to support an optical filter, in which the sub-housing includes a filter support part positioned in an inner region of the sub-housing adjoining the light transmission hole; and an outer collision mitigation part that protrudes further upward in the optical axis direction than the filter support part, and wherein the outer collision mitigation part is positioned to face the carrier in the optical axis direction.

### CROSS-REFERENCE TO RELATED APPLICATIONS

This application claims the benefit under 35 USC § 119(a) of Korean Patent Application No. 10-2024-0157472 filed on Nov. 7, 2024, in the Korean Intellectual Property Office the entire disclosure of which is incorporated herein by reference for all purposes.

### BACKGROUND

### 1. Field

The following description relates to a camera module.

### 2. Description of Related Art

With the recent trend toward the miniaturizing and the slimming down of the form factor of portable electronic devices, such as mobile phones, there has been a continuing effort to reduce sizes of components that are mounted in the electronic devices. Additionally, technologies that integrate various operations of the electronic components are being implemented. Camera modules, which is one of the electronic components, may be implemented for smartphones, notebook computers, and vehicles, as only examples.

With the increase in videography, the use of camera modules in portable smartphones has increased. Additionally, high-performance camera modules are also disposed in vehicles to implement a cutting-edge advanced driver assistance system (ADAS) to enable autonomous driving operations.

However, as the camera module has been highly pixelated and miniaturized, there is an increasing concern that the camera module may be damaged by forces applied from the outside.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a lens barrel; a carrier configured to accommodate the lens barrel; an image sensor disposed to face the lens barrel in an optical axis direction; a substrate electrically connected to the image sensor; and a sub-housing having a light transmission hole, and disposed between the lens barrel and the substrate, and configured to support an optical filter, wherein the sub-housing includes a filter support part positioned in an inner region of the sub-housing adjoining the light transmission hole; and an outer collision mitigation part that protrudes further upward in the optical axis direction than the filter support part, and wherein the outer collision mitigation part is positioned to face the carrier in the optical axis direction.

The sub-housing further may further include an inner collision mitigation part that is positioned between the filter support part and the outer collision mitigation part.

The inner collision mitigation part may protrude further upward in the optical axis direction than the filter support part, and the outer collision mitigation part may protrude further upward in the optical axis direction than the inner collision mitigation part.

The camera module may include a housing configured to accommodate the carrier.

The housing may include a sidewall having a preset height in the optical axis direction; and a lower wall that protrudes from a lower end portion of the sidewall toward the sub-housing.

The lower wall may be provided to face a lower end of the carrier in the optical axis direction.

A height of an upper surface of the outer collision mitigation part and a height of an upper surface of the lower wall of the housing may correspond to each other.

The carrier may include an inner sidewall which has a preset height in the optical axis direction; and an inner lower wall which protrudes from a lower end portion of the inner sidewall toward the lens barrel.

The inner lower wall of the carrier may face the outer collision mitigation part in the optical axis direction, and a lower end of the carrier may face the lower wall of the housing in the optical axis direction.

A distance by which the outer collision mitigation part and the inner lower wall are spaced apart from each other may correspond to a distance by which the lower wall and the lower end of the carrier are spaced apart from each other.

In a general aspect a camera module includes a lens barrel; a carrier configured to accommodate the lens barrel; an image sensor disposed to face the lens barrel in an optical axis direction; a substrate electrically connected to the image sensor; and a sub-housing disposed between the lens barrel and the substrate, and configured to support an optical filter, wherein at least a partial region of the sub-housing is positioned to face the carrier in the optical axis direction.

A light transmission hole may be positioned in the sub-housing, and the sub-housing may include a filter support part positioned in an inner region of the sub-housing adjoining the light transmission hole; and an outer collision mitigation part that protrudes further upward in the optical axis direction than the filter support part.

The outer collision mitigation part may face the carrier in the optical axis direction.

Other features and aspects will be apparent from the following detailed description, the drawings, and the claims.

### BRIEF DESCRIPTION OF DRAWINGS

FIG. 1 illustrates an example camera module, in accordance with one or more embodiments.

FIG. 2 illustrates an exploded perspective view of the example camera module in FIG. 1.

FIG. 3 illustrates a sub-housing in FIG. 2.

FIG. 4 illustrates a cross-sectional view taken along line A-A′ in FIG. 3.

FIG. 5 illustrates a cross-sectional view taken along line B-B′ in FIG. 1.

FIG. 6 illustrates region A in FIG. 5.

FIG. 7 illustrates a state in which constituent elements of the camera module collide with one another when a carrier moves downward.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In addition, throughout the specification, the phrase “in a plan view” means when an object is viewed from above, and the phrase “in a cross-sectional view” means when a cross section made by vertically cutting an object is viewed from a lateral side.

One or more examples may provide a camera module that is less likely to be damaged by a force applied from the outside.

Hereinafter, an optical axis OA direction, which is a direction parallel to a central axis of a lens accommodated in a lens barrel 10, may refer to a z-axis direction in the drawings. Further, a direction intersecting the optical axis OA direction may refer to an x-axis direction in the drawings, and a direction intersecting the optical axis OA direction and the x-axis direction may refer to a y-axis direction in the drawings. For example, the z-axis, the x-axis, and the y-axis may be orthogonal to each other.

Hereinafter, based on the optical axis OA direction, a direction, in which the lens barrel 10 is disposed with respect to a substrate 60, is referred to as an upward direction, and a direction, in which the substrate 60 is disposed with respect to the lens barrel 10, is referred to as a downward direction.

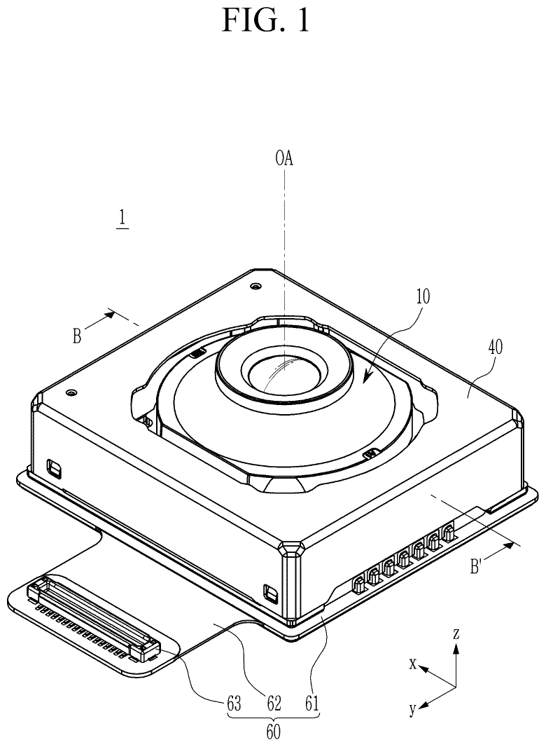

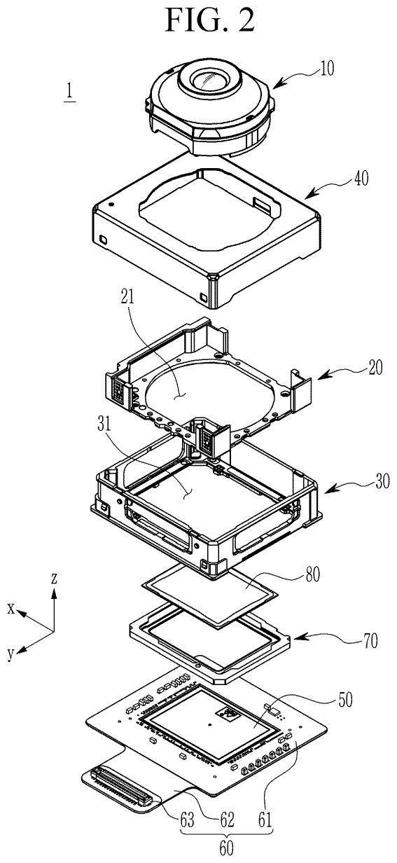

FIG. 1 is a view illustrating an example camera module 1, in accordance with one or more embodiments, and FIG. 2 is an exploded perspective view of the example camera module 1 in FIG. 1.

With reference to FIGS. 1 and 2, the camera module 1, in accordance with one or more embodiments, may include the lens barrel 10, a carrier 20, a housing 30, a cover 40, an image sensor 50, the substrate 60, and a sub-housing 70.

The lens barrel 10 may have a hollow column shape, and may accommodate therein at least one lens configured to capture an image of a subject. In an example, the lens barrel 10 may have a hollow cylindrical shape so as to accommodate therein a plurality of lenses. The plurality of lenses may be aligned in the optical axis OA direction, and may be mounted in the lens barrel 10. The plurality of lenses may be disposed in a state in which a desired number of lenses is determined in accordance with the implementation of the lens barrel 10. The plurality of lenses may be identical or different in optical characteristics, such as refractive indexes, to or from one another.

The carrier 20 may accommodate the lens barrel 10. A barrel alignment hole 21 may be positioned in a central region of the carrier 20. Further, the lens barrel 10 may be disposed in the barrel alignment hole 21, and may be aligned in the optical axis OA direction.

The housing 30 may accommodate the carrier 20. That is, an accommodation space may be positioned in the housing 30, and the carrier 20, which accommodates the lens barrel 10, may be accommodated in the housing 30. A sub-housing alignment hole 31 may be positioned in a central region of the housing 30. The housing 30 may have a polyhedral shape having an approximately quadrangular transverse section and a preset height. However, the one or more examples are not limited thereto. In an example, the housing 30 may have a box structure that is opened at upper and lower sides thereof. The carrier 20 may be accommodated in the housing 30 by being inserted into the housing 30 from above to below.

The carrier 20, which accommodates the lens barrel 10, may be movable in the optical axis OA direction relative to the housing 30. For example, the camera module 1 may include an auto-focus (AF) drive part. The AF drive part may include an AF drive magnet and an AF drive coil. In an example, the AF drive magnet may be mounted in the carrier 20. In an example, the AF drive magnet may be mounted on one surface of the carrier 20. The AF drive coil may be disposed to face the AF drive magnet. The AF drive magnet and the AF drive coil may be disposed to face each other in a direction perpendicular to the optical axis OA. In an example, the AF drive coil may be mounted on a lateral surface of the housing 30. When power is applied to the AF drive coil, the AF drive magnet and the carrier 20, in which the AF drive magnet is mounted, may be moved in the optical axis OA direction based on an electromagnetic force between the AF drive magnet and the AF drive coil.

The cover 40 may be connected to the housing 30, and may surround an outer surface of the housing 30. The cover 40 may protect internal configuration components in the camera module 1. Additionally, the cover 40 may block electromagnetic waves. For example, the cover 40 may block electromagnetic waves so that the electromagnetic waves generated in the camera module 1 do not affect the other electronic components in an electronic device in which the camera module 1 is mounted.

The image sensor 50 may face the lens barrel 10 in the optical axis OA direction. The image sensor 50 may be disposed below the lens barrel 10 based on the optical axis OA direction. The image sensor 50 may convert light, which enters the image sensor 50 after passing through the lens barrel 10, into an electrical signal. In a non-limited example, the image sensor 50 may be a charge-coupled device (CCD), a metal oxide semiconductor (MOS), a charge priming device (CPD), a charge injection device (CID), a complementary metal-oxide semiconductor (CMOS), as only examples. The electrical signal converted by the image sensor 50 may be outputted as an image through a display device of the electronic device such as a smartphone. The image sensor 50 may be electrically connected to the substrate 60. For example, the image sensor 50 may be connected directly to the substrate 60 by wire bonding. Two opposite ends of a wire may be respectively bonded to a connection terminal of the image sensor 50 and a connection terminal of the substrate 60.

The substrate 60 may be disposed below the housing 30. The image sensor 50 may be mounted on the substrate 60. The substrate 60 may transmit an image signal, which is transmitted from the image sensor 50, to another constituent element included in the electronic device in which the camera module 1 is mounted. The electrical signal converted by the image sensor 50 may be outputted as an image through a display device of the portable electronic device.

The substrate 60 may include a main mounting part 61, a connection substrate part 62, and a connector 63.

The main mounting part 61 may have a preset area. The image sensor 50 may be mounted on the main mounting part 61. The housing 30 may be disposed on the main mounting part 61. The main mounting part 61 may be a printed circuit board (PCB), a flexible printed circuit board (FPCB), as only examples.

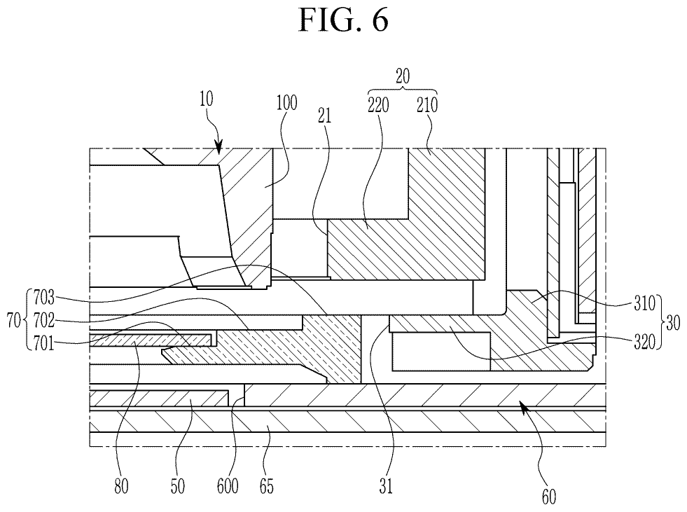

Referring to FIG. 6, an opening portion 600 may be provided in a central region of the main mounting part 61. The opening portion 600 may be formed through two opposite surfaces of the main mounting part 61. Therefore, spaces positioned at two opposite sides of the main mounting part 61 may be connected to each other in the optical axis OA direction through the opening portion 600. The opening portion 600 may have a shape corresponding to a shape of the image sensor 50. An area of the opening portion 600 may be equal to, or larger than, an area of the image sensor 50. Therefore, the image sensor 50 may be disposed in the opening portion 600.

The image sensor 50 is disposed in the opening portion (600 in FIG. 6) of the main mounting part 61, and then the image sensor 50 and the main mounting part 61 are electrically connected, such that the spatial efficiency may be maximized, and the size of the camera module 1 may be reduced.

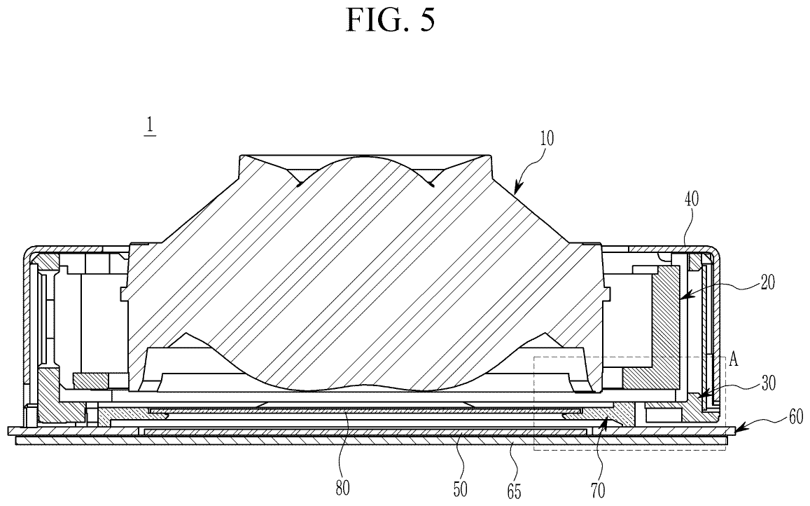

A reinforcement member (65 in FIG. 5) may be disposed at one side of the main mounting part 61. The reinforcement member 65 may be disposed opposite to the lens barrel 10 based on the main mounting part 61. The reinforcement member 65 may be disposed below the main mounting part 61 based on the optical axis OA direction. The reinforcement member 65 may be joined to the main mounting part 61. The reinforcement member 65 may support the main mounting part 61 and prevent the main mounting part 61 from being deformed or damaged by an external force.

One end of the connection substrate part 62 may be connected to the main mounting part 61. The other end of the connection substrate part 62 may be connected to the connector 63. The connection substrate part 62 electrically connects the main mounting part 61 and the connector 63. That is, an electrical signal of the main mounting part 61 may be transmitted to the connector 63 through the connection substrate part 62. The connection substrate part 62 may include an FPCB or the like. The camera module 1 may be electrically connected to an external device through the connector 63.

The sub-housing 70 may be disposed on the substrate 60. The sub-housing 70 may be disposed on the main mounting part 61. The sub-housing 70 may be disposed between the lens barrel 10 and the substrate 60. Additionally, at least a partial region of the sub-housing 70 may be positioned between the substrate 60 and the carrier 20. That is, at least a partial region of the sub-housing 70 may be provided to face the carrier 20 in the optical axis OA direction. The sub-housing 70 may support an optical filter 80. The optical filter 80 may be disposed between the lens barrel 10 and the image sensor 50. The optical filter 80 may filter out light beams with preset wavelength bands among light beams entering the optical filter 80 in the lens barrel 10 direction. Therefore, among the light beams entering the lens barrel 10, the light beams with the preset wavelength bands may be filtered out while passing through the optical filter 80, and the light beams with the remaining wavelength bands may enter the image sensor 50. For example, the optical filter 80 may filter out infrared rays.

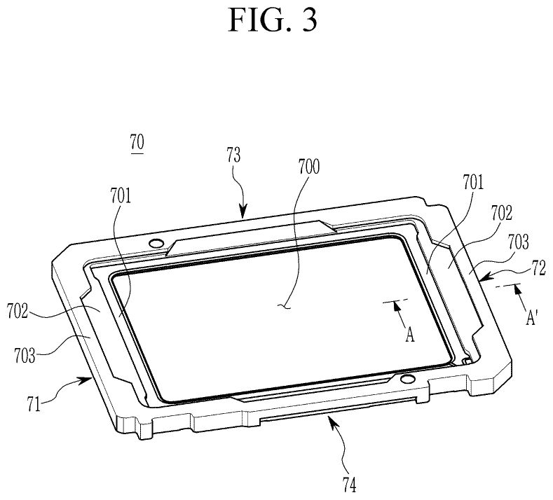

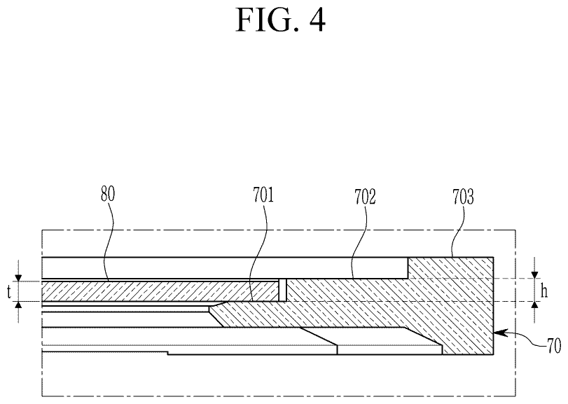

FIG. 3 is a view illustrating the sub-housing 70 in FIG. 2, and FIG. 4 is a cross-sectional view taken along line A-A′ in FIG. 3.

For convenience of description, FIG. 6 also illustrates the optical filter 80.

With reference to FIGS. 3 and 4, in an example, the sub-housing 70 may have a ring structure, and a light transmission hole 700 may be positioned at an inner center of the sub-housing 70. In an example, an area of the light transmission hole 700 may be smaller than an area of a lower end of the lens barrel 10.

The sub-housing 70 may include a filter support part 701, an inner collision mitigation part 702, and an outer collision mitigation part 703.

The filter support part 701 supports the optical filter 80. Based on the direction intersecting the optical axis OA, the filter support part 701 may be positioned in an inner region of the sub-housing 70 that adjoins the light transmission hole 700. The filter support part 701 may be positioned along a circumference of the light transmission hole 700. The filter support part 701 may have a structure corresponding to an outer periphery of the optical filter 80. Therefore, when the sub-housing 70 supports the optical filter 80, an edge region of the optical filter 80 may be positioned on the filter support part 701, and the remaining region of the optical filter 80 may be positioned on the light transmission hole 700.

The inner collision mitigation part 702 may be provided to protrude further upward in the optical axis direction than the filter support part 701. Based on the direction intersecting the optical axis OA, an inner region of the inner collision mitigation part 702 may adjoin the filter support part 701. That is, the filter support part 701 may also be understood as having a structure that is further recessed downward by a preset depth than the inner collision mitigation part 702. A height h of the inner collision mitigation part 702 may be equal to or larger than a thickness t of the optical filter 80. In this example, the height h of the inner collision mitigation part 702 may be a height difference between the filter support part 701 and the inner collision mitigation part 702 in the optical axis OA direction. An upper surface of the inner collision mitigation part 702 may have a planar structure.

The sub-housing 70 may include a first frame part 71, a second frame part 72, a third frame part 73, and a fourth frame part 74. The first frame part 71 may face the second frame part 72 with the light transmission hole 700 interposed therebetween. The third frame part 73 may face the fourth frame part 74 with the light transmission hole 700 interposed between. The inner collision mitigation part 702 may be positioned on at least one of the first frame part 71, the second frame part 72, the third frame part 73, and the fourth frame part 74. FIG. 3 illustrates that the inner collision mitigation part 702 is positioned on the first frame part 71 and the second frame part 72.

The outer collision mitigation part 703 may be provided to protrude further upward than the filter support part 701. The outer collision mitigation part 703 may be provided to protrude further upward than the inner collision mitigation part 702. The inner collision mitigation part 702 may be positioned between the filter support part 701 and the outer collision mitigation part 703. Based on the direction intersecting the optical axis OA, an inner region of the outer collision mitigation part 703 may adjoin the inner collision mitigation part 702. Based on the direction intersecting the optical axis OA, the outer collision mitigation part 703 may be positioned in a region opposite to the light transmission hole 700, i.e., positioned in an outer region of the sub-housing 70. An upper surface of the outer collision mitigation part 703 may have a planar structure.

FIG. 5 is a cross-sectional view taken along line B-B′ in FIG. 1, and FIG. 6 is a view illustrating region A in FIG. 5.

With reference to FIGS. 5 and 6, the housing 30 may include a sidewall 310 and a lower wall 320. The sidewall 310 may have a preset height in the optical axis OA direction. An accommodation space, in which the carrier 20 is accommodated, may be positioned inside the sidewall 310. A hole or groove, which is formed through the sidewall 310 in the direction intersecting the optical axis OA, may be positioned in a partial section of the sidewall 310.

The lower wall 320 may be connected to a lower end portion of the sidewall 310 of the housing 30. The lower wall 320 may protrude from the lower end portion of the sidewall 310 toward the accommodation space in the housing 30. That is, the lower wall 320 may protrude from the lower end portion of the sidewall 310 toward the sub-housing 70. Further, the sub-housing alignment hole 31 may be positioned in a central region of the lower wall 320. Therefore, when the housing 30 is disposed on the substrate 60, the sub-housing 70 may be disposed in the sub-housing alignment hole 31. The lower wall 320 may be provided to be spaced apart from the sub-housing 70.

The carrier 20 may include an inner sidewall 210 and an inner lower wall 220. The inner sidewall 210 may have a preset height in the optical axis OA direction. A barrel accommodation space, in which the lens barrel 10 is accommodated, may be positioned inside the inner sidewall 310. A hole or groove, which is formed through the inner sidewall 310 in the direction intersecting the optical axis OA, may be positioned in a partial section of the inner sidewall 310.

The inner lower wall 220 may be connected to a lower end portion of the inner sidewall 210. The inner lower wall 220 may protrude from a lower end portion of the inner sidewall 210 toward the barrel accommodation space in the carrier 20. That is, the inner lower wall 220 may protrude from the lower end portion of the inner sidewall 210 toward the lens barrel 10. Further, the barrel alignment hole 21 may be positioned in a central region of the inner lower wall 220.

A lower end of the carrier 20 may be provided to face at least a partial region of the sub-housing 70 in the optical axis OA direction. The inner lower wall 220 of the carrier 20 may be provided to face at least a partial region of the outer collision mitigation part 703 of the sub-housing 70 in the optical axis OA direction. Additionally, the lower end of the carrier 20 may face at least a partial region of the housing 30 in the optical axis OA direction. The lower end of the carrier 20 may be provided to face the lower wall 320 of the housing 30 in the optical axis OA direction. That is, at least a partial region of the inner lower wall 220 of the carrier 20 may protrude further toward the lens barrel 10 than the lower wall 320 of the housing 30. Therefore, the lower end of the inner sidewall 210 of the carrier 20 may face the lower wall 320 of the housing 30 in the optical axis OA direction. Additionally, a partial region of the inner lower wall 220 of the carrier 20 may face the lower wall 320 of the housing 30 in the optical axis OA direction. Additionally, a partial region of the inner lower wall 220 of the carrier 20 may face the outer collision mitigation part 703 of the sub-housing 70 in the optical axis OA direction.

When the sub-housing 70 and the housing 30 are disposed on the substrate 60, a height of an upper surface of the outer collision mitigation part 703 and a height of an upper surface of the lower wall 320 of the housing 30 may correspond to each other. Therefore, a distance by which the outer collision mitigation part 703 of the sub-housing 70 and the inner lower wall 220 of the carrier 20 are spaced apart from each other in the optical axis OA direction may correspond to a distance by which the lower wall 320 of the housing 30 and the lower end of the carrier 20 are spaced apart from each other in the optical axis OA direction.

At least a part of an outer edge region of a lower end of the lens barrel 10 may face the inner collision mitigation part 702 in the optical axis OA direction. For example, a protruding portion 100 may be positioned in at least a partial region of an outer edge of the lower end portion of the lens barrel 10. The protruding portion 100 may be provided to further protrude downward than the adjacent region of the outer edge region of the lower end of the lens barrel 10. Therefore, the protruding portion 100 may be provided to be lowest in height in an upward/downward direction in the outer edge region of the lower end of the lens barrel 10. Further, the protruding portion 100 may be positioned only in the inner collision mitigation part 702 when viewed in the optical axis OA direction.

Accordingly, an area of the inner collision mitigation part 702 may be larger than an area of a lower end of the protruding portion 100 of the barrel 10. A distance by which the protruding portion 100 and the inner collision mitigation part 702 of the sub-housing 70 are spaced apart from each other in the optical axis OA direction may be longer than a distance by which the outer collision mitigation part 703 of the sub-housing 70 and the carrier 20 are spaced apart from each other in the optical axis OA direction.

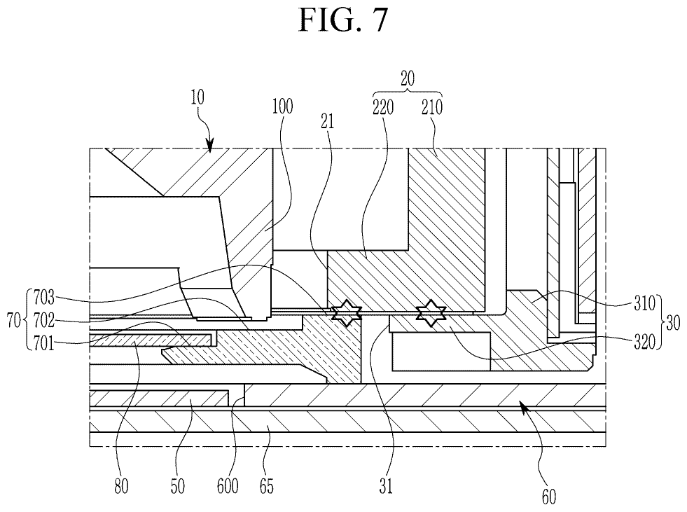

FIG. 7 illustrates an example in which constituent elements of the camera module 1 collide with one another when the carrier 20 moves downward in the optical axis direction.

With reference to FIG. 7, the carrier 20 and the lens barrel 10, in which the carrier 20 is accommodated, moves in the optical axis OA direction during the process in which the camera module 1 is used. The movement of the carrier 20 may be generated not only by a normal operation of the AF drive part but also by an impact applied from the outside. When the lens barrel 10 collides with the constituent element of the camera module 1 positioned there-below by the above-mentioned abnormal movement of the carrier 20, the lens barrel 10, the optical filter 80, the image sensor 50, and the like may be damaged.

In contrast, the camera module 1 according to the embodiment is provided such that the carrier 20 faces the outer collision mitigation part 703 of the sub-housing 70 in the optical axis OA direction. Therefore, even in an example in which the carrier 20 is moved downward by an impact, the carrier 20 and the outer collision mitigation part 703 of the sub-housing 70 collide with each other first before the lens barrel 10 collides with the sub-housing 70. The collision between the carrier 20 and the outer collision mitigation part 703 of the sub-housing 70 may prevent the carrier 20 and the lens barrel 10 from additionally moving downward, thereby preventing the lens barrel 10 from colliding with the constituent element at the lower side.

Additionally, the collision between the carrier 20 and the outer collision mitigation part 703 of the sub-housing 70 primarily cancels out an impact applied from the outside, such that the amount of impact applied between the lens barrel 10 and another constituent element may be reduced even though the lens barrel 10 additionally moves downward.

Additionally, in an example in which the distance by which the outer collision mitigation part 703 of the sub-housing 70 and the carrier 20 are spaced apart from each other in the optical axis OA direction corresponds to the distance by which the lower wall 320 of the housing 30 and the carrier 20 are spaced apart from one another in the optical axis OA direction, the collision between the carrier 20 and the sub-housing 70 and the collision between the carrier 20 and the housing 30 may occur almost simultaneously. Therefore, the amount of impact may be dispersed by the two collisions, which may more effectively attenuate an impact applied from the outside.

In addition, even in an example in which the lens barrel 10 additionally moves downward relative to the carrier 20 after the carrier 20 collides with the components positioned at the lower side, the lens barrel 10 may collide with the inner collision mitigation part 702, which may prevent a collision between the lens barrel 10 and the optical filter 80.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a lens barrel;
a carrier configured to accommodate the lens barrel;
an image sensor disposed to face the lens barrel in an optical axis direction;
a substrate electrically connected to the image sensor; and
a sub-housing having a light transmission hole, and disposed between the lens barrel and the substrate, and configured to support an optical filter,
wherein the sub-housing comprises:
a filter support part positioned in an inner region of the sub-housing adjoining the light transmission hole; and
an outer collision mitigation part that protrudes further upward in the optical axis direction than the filter support part, and
wherein the outer collision mitigation part is positioned to face the carrier in the optical axis direction.

2. The camera module of claim 1, wherein:
the sub-housing further comprises an inner collision mitigation part that is positioned between the filter support part and the outer collision mitigation part.

3. The camera module of claim 2, wherein:
the inner collision mitigation part protrudes further upward in the optical axis direction than the filter support part, and
the outer collision mitigation part protrudes further upward in the optical axis direction than the inner collision mitigation part.

4. The camera module of claim 1, further comprising:
a housing configured to accommodate the carrier.

5. The camera module of claim 4, wherein:
the housing comprises:
a sidewall having a preset height in the optical axis direction; and
a lower wall that protrudes from a lower end portion of the sidewall toward the sub-housing.

6. The camera module of claim 5, wherein:
the lower wall is provided to face a lower end of the carrier in the optical axis direction.

7. The camera module of claim 5, wherein:
a height of an upper surface of the outer collision mitigation part and a height of an upper surface of the lower wall of the housing correspond to each other.

8. The camera module of claim 5, wherein:
the carrier comprises:
an inner sidewall which has a preset height in the optical axis direction; and
an inner lower wall which protrudes from a lower end portion of the inner sidewall toward the lens barrel.

9. The camera module of claim 8, wherein:
the inner lower wall of the carrier faces the outer collision mitigation part in the optical axis direction, and
a lower end of the carrier faces the lower wall of the housing in the optical axis direction.

10. The camera module of claim 9, wherein:
a distance by which the outer collision mitigation part and the inner lower wall are spaced apart from each other corresponds to a distance by which the lower wall and the lower end of the carrier are spaced apart from each other.

11. A camera module, comprising:
a lens barrel;
a carrier configured to accommodate the lens barrel;
an image sensor disposed to face the lens barrel in an optical axis direction;
a substrate electrically connected to the image sensor; and
a sub-housing disposed between the lens barrel and the substrate, and configured to support an optical filter,
wherein at least a partial region of the sub-housing is positioned to face the carrier in the optical axis direction.

12. The camera module of claim 11, wherein:
a light transmission hole is positioned in the sub-housing, and
wherein the sub-housing comprises:
a filter support part positioned in an inner region of the sub-housing adjoining the light transmission hole; and
an outer collision mitigation part that protrudes further upward in the optical axis direction than the filter support part.

13. The camera module of claim 12, wherein:
the outer collision mitigation part faces the carrier in the optical axis direction.
